(19) United States
(12) Patent Application Publication
(10) Pub. No.: US 2016/0081336 A1
(43) Pub. Date: Mar. 24, 2016

(54) MEDIUM WITH A PLANT NON-METABOLIZABLE SUGAR FOR IMPROVING SEED GERMINATION

(71) Applicant: WEYERHAEUSER NR COMPANY, Federal Way, WA (US)

(72) Inventors: Jeffrey E. Hartle, Bonney Lake, WA (US); Craig N. Cootsona, Tacoma, WA (US); William C. Carlson, Olympia, WA (US); Katie A. Brinkerhoff, Puyallup, WA (US); James A. Grob, Bonney Lake, WA (US)

(73) Assignee: WEYERHAEUSER NR COMPANY, FEDERAL WAY, WA (US)

(21) Appl. No.: 14/851,331

(22) Filed: Sep. 11, 2015

Related U.S. Application Data
(60) Provisional application No. 62/052,211, filed on Sep. 18, 2014.

(51) Int. Cl. A01N 43/16; C05C 5/02; C05C 1/00; A01C 1/06; C05D 1/00; C05B 17/00; C05D 5/00; C05F 11/10; C05F 11/00; C05D 9/02

(52) U.S. Cl. CPC A01N 43/16; C05F 11/00; C05C 5/02; C05C 1/00; C05D 9/02; C05D 1/00; C05B 17/00; C05D 5/00; C05F 11/10; A01C 1/06

(57) ABSTRACT

What is described is a nutritive media for a manufactured seed comprising a plant non-metabolizable sugar and a manufactured seed comprising plant non-metabolizable sugar in its nutritive medium

### CROSS-REFERENCE TO RELATED APPLICATION

This application is entitled to and claims the benefit of priority under 35 U.S.C. §119 from U.S. Nonprovisional Patent Application Ser. No. 62/052,211 filed Sep. 18, 2014, and titled “Medium with a Plant Non-Metabolize Sugar for Improving Seed Germination,” the contents of which are incorporated herein by reference.

### TECHNICAL FIELD

The technical field includes a nutritive media for a manufactured seed comprising a non-metabolizable sugar, a manufactured seed comprising non-metabolizable sugar in its nutritive medium, and a method of improving germination of plant embryos using a non-metabolizable sugar.

### BACKGROUND

It is often desirable to plant large numbers of genetically identical plants that have been selected to have advantageous properties, but in many cases it is not feasible to produce such plants using standard breeding techniques. In vitro culture of somatic or zygotic plant embryos can be used to produce large numbers of genetically identical embryos that have the capacity to develop into normal plants. However, the resulting embryos lack the protective and nutritive structures found in natural botanic seeds that shelter the plant embryo inside the seed from the harsh soil environment and nurture the embryo during the critical stages of sowing and germination. Attempts have been made to provide such protective and nutritive structures by using manufactured seeds, but so far germination from manufactured seeds is less successful than from natural seeds. There remain large differences between manufactured seeds and corresponding natural seeds. Whereas the embryo relies on the megagametophyte for nutrients useful for germination, the embryo in a manufactured seed relies on the nutritive medium that is provided in the manufactured seed.

Embryo vigor and root competence remain common and particularly challenging issues that reduce germination from somatic embryos across many species. One approach to improving both properties involves modification of the gametophyte medium sugar content and optimal osmotic potential within the manufactured seed construct. Sugar remains the primary carbon source within manufactured seed, so embryos situated within the cotyledon restraint rely on osmotic gradients, mass flow, and matric potential for delivery.

Increased sugar content in the gametophyte proportionally affects osmotic potential so the two become confounded if one simply increases sugar content. It is necessary to separate carbon source from osmotic potential variables to determine how each affects plant germination and growth.

Non-plant-metabolizable sugars have been identified, including turanose (3-O-α-d-glucopyranosyl-D-fructopyranose), isomaltulose (PALATINOSE®) (6-O-α-d-glucopyranosyl-D-fructose), lactulose (4-O-β-D-galactopyranosyl-β-D-fructofuranose), 3α-galactobiose (3-O-α-D-galactopyranosyl-D-galactopyranose), lactitol (4-O-α-D-galactopyranosyl-D-glucitol), lactose (4-O-β-D-galactopyranosyl-D-glucose), 4β-galactobiose (4-O-β-D-galactopyranosyl-D-galactopyranose), palatinitol (a 1:1 mixture of 6-O-α-D-glucopyranosyl-D-glucitol and 6-O-α-D-glucopyranosyl-D-mannitol), and melibiose (6-α-D-galactopyranosyl-D-glucopyranose), having structures shown below.

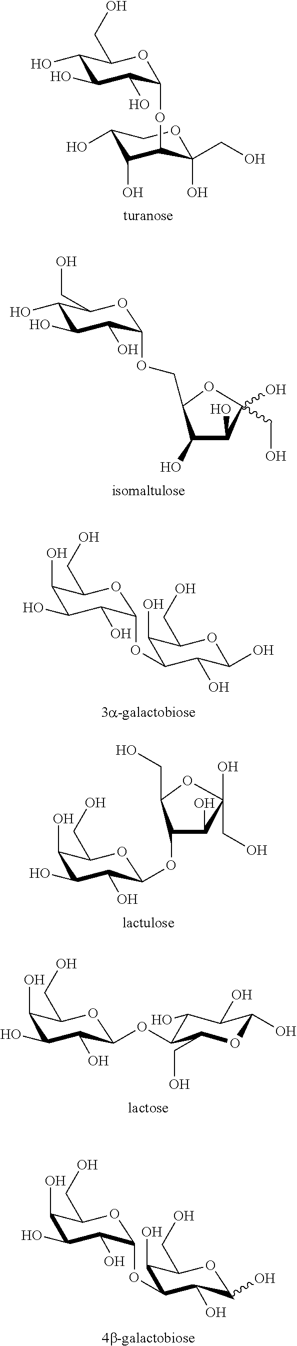

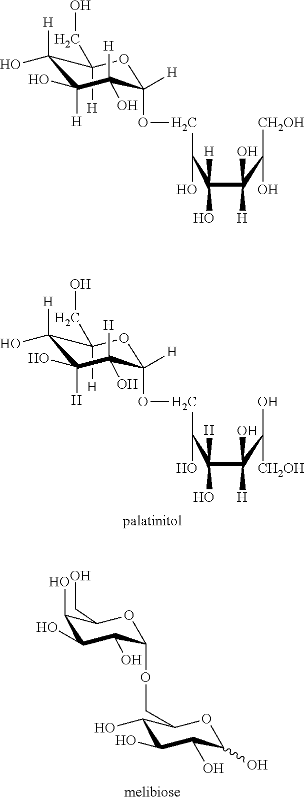

### See Loreti, et al., 2000, Plant Phys 123: 939-48; Fernie, et al., 2001, Plant Phys 125:1967-77; Sinha et al., 2002, Plant Physiol 128:1480-89; and Loreti et al., 2001, Ann Botany 88:803-12.

A medium for culturing potato tuber cuttings for up to twelve hours that included up to 100 mM isomaltulose was previously described (Fernie et al., 2001). This medium was not a nutritive medium intended for germination or embryogenesis. A medium containing up to 100 mM isomaltulose for culturing dissected barley embryos for up to 24 hours was described (Loreti et al., 2000). Again, the medium was intended to generate a short-term response followed by destructive analysis. In addition, Loreti et al. tested 200 mM isomaltulose effects on dry weight after 48 hours of treatment, but without another carbon source, to demonstrate the embryos' inability to metabolize isomaltulose as the only carbohydrate source. A photo-autotrophic medium for a suspension of cultured tomato cells was described that included a isomaltulose treatment up to 50 mM for 48 hour or more to 200 mM for five minutes (Sinha et al., 2002).

Therefore, there remains a need for generating improved nutritive medium that is useful for improving rates of conversion for manufactured seeds containing somatic embryos to provide a large number of normal germinants.

### SUMMARY

What is described is a nutritive media for a manufactured seed comprising a plant non-metabolizable sugar. The non-metabolizable sugar preferably is at a concentration of at least 1 g/l or at most 40 g/l. The plant non-metabolizable sugar may be one or more of the following sugars: turanose, isomaltulose, lactulose, 3α-galactobiose, lactitol, lactose, 4β-galactobiose, palatinitol, and melibiose. The nutritive media may further comprise glucose or sucrose, e.g., at a concentration of at least 30 g/l.

The nutritive media may further comprise at least eight components selected from the group consisting of: charcoal, a carbon source, urea, KNO₃, NH₄NO₃, CuCl₂, CuSO₄, KI, KH₂PO₄, CaCl₂, MgSO₄, Na₂EDTA, FeSO₄, ferric citrate, MnSO₄, MnCl₂, H₃BO₃, ZnSO₄, CoCl₂, Na₂MoO₄, (NH₄)₂MoO₄, thiamine, riboflavin, pyridoxine, HCl, Ca-pantothenate, nicotinic acid, biotin, folic acid, and myo-inositol. The nutritive media may further comprise at least one component selected from the group consisting of from 10 g/l to 100 g/l of an adsorbent material, from 350 mg/l to 450 mg/l NH₄NO₃, from 2000 mg/l to 3000 mg/l KH₂PO₄; from 5 mg/l to 25 mg/l FeSO₄, from 600 mg/l to 1500 mg/l MgSO₄, from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l riboflavin, from 0.75 mg/l to 2.0 mg/l Ca-pantothenate, from 0.01 mg/l to 0.03 mg/l of biotin and from 0.15 mg/l to 0.30 mg/l of folic acid.

Another aspect of the description is a manufactured seed comprising a seed coat and a nutritive media comprising a plant non-metabolizable sugar, preferably at a concentration of at least 1 g/l and at most 40 g/l. The plant non-metabolizable sugar may be one or more of the following sugars: turanose, isomaltulose, lactulose, 3α-galactobiose, lactitol, lactose, 4β-galactobiose, palatinitol, and melibiose. The manufactured seed may also comprise at least one component selected from the group consisting of from 10 g/l to 100 g/l an adsorbent material, from 350 mg/l to 450 mg/l NH₄NO₃, from 2000 mg/l to 3000 mg/l KH₂PO₄; and at least one component selected from the group consisting of: from 5 mg/l to 25 mg/l FeSO₄, from 600 mg/l to 1500 mg/l MgSO₄, from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l riboflavin, from 0.75 mg/l to 2.0 mg/l Ca-pantothenate, from 0.01 mg/l to 0.03 mg/l biotin and from 0.15 mg/l to 0.30 mg/l folic acid.

The manufactured seed may comprise a plant non-metabolizable sugar as an osmotic agent of the nutritive media.

The manufactured seed may comprise a conifer embryo. The manufactured seed may comprise a shoot restraint, wherein the shoot restraint comprises a cavity sized to receive a conifer embryo. The manufactured seed may further comprise an embryo disposed in the cavity of the shoot restraint.

What is also described is a method for improving germination of a manufactured seed, comprising: culturing a plant embryo in a germination medium comprising a plant non-metabolizable sugar to form a cultured plant embryo; and assembling the cultured embryo into a manufactured seed. For example, the plant embryo may comprise a loblolly pine embryo. A plant non-metabolizable sugar may improve embryo root elongation, root presence, lateral root presence, epicotyl length, or seed extraction normalcy compared to culturing the embryo in a germination medium without a plant non-metabolizable sugar.

The method may include a plant non-metabolizable sugar at a concentration of at least 1 g/l or at most 40 g/l. The plant non-metabolizable sugar may be one or more of the following sugars: turanose, isomaltulose, lactulose, 3α-galactobiose, lactitol, lactose, 4β-galactobiose, palatinitol, and melibiose. The method may include nutritive media that further comprises at least one component selected from the group consisting of from 10 g/l to 100 g/l of an adsorbent material, from 350 mg/l to 450 mg/l NH₄NO₃, from 2000 mg/l to 3000 mg/l KH₂PO₄, from 5 mg/l to 25 mg/l FeSO₄, from 600 mg/l to 1500 mg/l MgSO₄, from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l of riboflavin, from 0.75 mg/l to 2.0 mg/l of Ca-pantothenate, from 0.01 mg/l to 0.03 mg/l biotin, and from 0.15 mg/l to 0.30 mg/l folic acid.

What is also described is a method for improving germination of a plant zygotic or somatic embryo, comprising: culturing the plant embryo in a germination medium comprising a plant non-metabolizable sugar; and assembling the plant embryo into a manufactured seed. The method may comprise a loblolly pine embryo. The method may use a plant non-metabolizable sugar to improve embryo root elongation, root presence, lateral root presence, epicotyl length, or seed extraction normalcy compared to culturing the embryo in a germination medium without a plant non-metabolizable sugar. The a plant non-metabolizable sugar is preferably used at a concentration of at least 1 g/l and at most 40 g/l. The plant non-metabolizable sugar may be one or more of the following sugars: turanose, isomaltulose, lactulose, 3α-galactobiose, lactitol, lactose, 4β-galactobiose, palatinitol, and melibiose. The method may use nutritive media further comprising at least one component selected from the group consisting of from 10 g/l to 100 g/l of an adsorbent material, from 350 mg/l to 450 mg/l NH₄NO₃, from 2000 mg/l to 3000 mg/l KH₂PO₄, from 5 mg/l to 25 mg/l FeSO₄, from 600 mg/l to 1500 mg/l MgSO₄, from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l riboflavin, from 0.75 mg/l to 2.0 mg/l Ca-pantothenate, from 0.01 mg/l to 0.03 mg/l biotin, and from 0.15 mg/l to 0.30 mg/l folic acid.

### BRIEF DESCRIPTION OF THE DRAWINGS

FIG. 1 shows a side cross-sectional planar view of an exemplary manufactured seed 20 comprising a plant embryo 42 disposed within. An embryo 42 is disposed within a cavity 34, in functional contact with nutritive media 26 and suitably sealed therein by a live end seal 43. The manufactured seed 20 also comprises a seed coat 24, a dead end seal 28, and an optional cylcap 22 (shoot restraint).

FIG. 2 shows that organ lengths increased with sucrose at 50 g/l and greater. Levels above 50 g/l were not significantly different from 50 g/l.

FIG. 3 shows that normalcy decreased with increasing sucrose concentration.

FIG. 4 shows results confirming that increased root length with relation to rising sucrose levels. With respect to hypocotyl, cotyledon and epicotyl, no significant changes in length were detected.

FIG. 5 shows that on day 5 there is an indirect proportion between sucrose concentration and embryo activity. Lower concentrations of sucrose gave the highest yield of embryo activity.

FIG. 6 shows results that demonstrate normalcy increasing with higher sucrose concentrations (comparing normal and not normal lines).

FIG. 7 shows sucrose movement across membranes and location of invertases (modeled as photosynthate coming from the phloem stream). The circles represent transporters to facilitate sugar-specific uptake. SPS, sucrose-P synthase; SPP, sucrose-P phosphatase; AGPase, ADP-glc pyrophosphorylase; UGPase, UDP-glucose pyrophosphorylase; INV, invertase; C-INV, cytosolic INV; CW-INV, cell wall INV; V-INV, vacuolar INV; SUS, sucrose synthase (from Rolland et al., 2006, Ann Rev Plant Biol 57:675-709).

FIG. 8 shows differences in root length with respect to treatment groups:
T1) 20 g/l sucrose (T1: 20 Suc);
T2) 20 g/l sucrose+10 g/l isomaltulose (T2: 20 Suc+10 Iso);
T3) 30 g/l sucrose (T3: 30 Suc);
T4) 30 g/l sucrose+10 g/l isomaltulose (T4: 30 Suc+10 Iso);
T5) 40 g/l sucrose (T5: 40 Suc).
   20 sucrose and 20 sucrose+10 isomaltulose, which have the same amount of utilizable carbon, appear to differ. Organ length is plotted as a function of osmolality. 20 sucrose+10 isomaltulose unexpectedly performed better than 20 sucrose. In addition, 20 sucrose+10 isomaltulose performed similarly to 30 sucrose (same osmotic potential).

FIG. 9 shows that normalcy differed significantly between 20 sucrose and all others but not among 20 sucrose+10 isomaltulose, 30 sucrose, 30 sucrose+10 isomaltulose or 40 sucrose. The media composition is the same as in FIG. 8. The results suggest that embryos with only 20 g/L sucrose failed to receive adequate carbon from the medium.

FIG. 10 shows that the incidence of lateral roots increased with osmolality but 20 sucrose+10 isomaltulose had a slightly lower incidence of lateral roots compared to 30 sucrose. Incidence is plotted as a function of osmolality of the media.

FIG. 11 shows the final results for zygotic germination. Zygotic embryos were cultured for 56 days in non-sterile conditions. The percentage germination is shown for four different MS-11 media additives: 1) 40 g/l sucrose; 2) 30 g/l glucose; 3) 30 g/l glucose+20 g/l isomaltulose; and 4) 30 g/l glucose+40 g/l isomaltulose.

### DETAILED DESCRIPTION OF ILLUSTRATIVE EMBODIMENTS

The present disclosure provides manufactured seeds comprising a modified nutritive medium comprising a plant non-metabolizable sugar that results in improved germination frequency in comparison to manufactured seeds comprising standard nutritive medium.

As used herein the “plant non-metabolizable sugar” may be selected from the group consisting of turanose, isomaltulose, lactulose, 3α-galactobiose, lactitol, lactose, 4β-galactobiose, palatinitol, and melibiose.

As used herein, “a plant somatic embryo” refers to an embryo produced by culturing totipotent plant cells such as meristematic tissue under laboratory conditions in which the cells comprising the tissue are separated from one another and urged to develop into minute complete embryos. Alternatively, somatic embryos can be produced by inducing “cleavage polyembryogeny” of zygotic embryos. Methods for producing plant somatic embryos suitable for use in the methods of the description are standard in the art and have been previously described. For example, plant tissue may be cultured in an initiation medium that includes hormones to initiate the formation of embryogenic cells, such as embryonic suspensor masses that are capable of developing into somatic embryos. The embryogenic cells may then be further cultured in a maintenance medium that promotes establishment and multiplication of the embryogenic cells. Subsequently, the multiplied embryogenic cells may be cultured in a development medium that promotes the development of somatic embryos, which may further be subjected to post-development treatments such as cold treatments. The somatic embryos used in the methods of the description have completed the development stage of the somatic embryogenesis process. They may also have been subjected to one or more post-development treatments.

Typically, the plant somatic embryos used in the description have a shoot end and a root end. In some species of plants, the shoot end includes one or more cotyledons (leaf-like structures) at some stage of development. Plant embryos suitable for use in the methods described herein may be embryos from any plant species, such as dicotyledonous or monocotyledonous plants or gymnosperms, such as conifer zygotic or somatic embryos (i.e., pine, such as Loblolly pine, fir, or Douglas-fir). For use in manufactured seeds according to the present description, the plant embryo is developed sufficiently to have a shoot end and a radicle end. In certain species of plants, the shoot end includes one or more cotyledons in some stage of development. In other types of plants, the cotyledon(s) are situated in locations other than the shoot end.

As used herein, the term “germination” refers to a physiological process that results in the elongation of a plant embryo along its axis and is complete when the embryo has elongated to the point of protrusion through the seed coat or manufactured seed lid.

As used herein, the term “complete germination” refers to a manufactured seed having root protrusion through the seed coat or manufactured seed lid.

Normal (germination score): Fully extracted out of seed with no malformation (epicotyl optional for fully extracted). OR partial germinant with epicotyl out of cavity and all organs—No Malformations present. Root length of at least 3.0 mm.

Partial Normal (germination score): Not fully emerged, partial germinant with no epicotyl and no malformations. Root length of at least 3.0 mm.

Not normal (germination score): Malformed partial germinants, lacking organs, roots less than 3 mm, any upside down or twisted germinant, or germinated and died as evidenced by lid penetration but no germinant present.

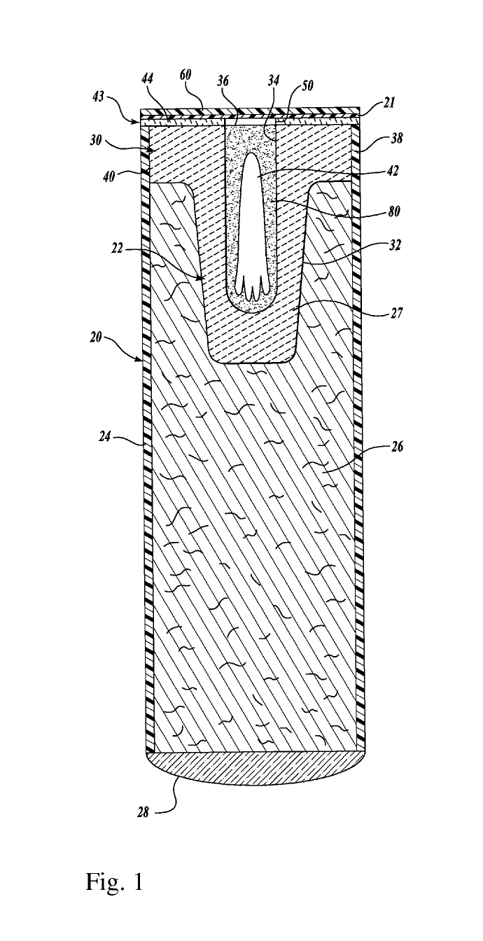

A manufactured seed for use in the description comprises a plant embryo, a manufactured seed coat, and a nutritive medium. FIG. 1 is a side cross-sectional planar view of an exemplary manufactured seed 20 comprising a plant embryo 42 disposed within. As shown in FIG. 1, the embryo 42 is disposed within a cavity 34, is in functional contact with nutritive media 26 and is suitably sealed therein by a live end seal 43. It will be understood that FIG. 1 provides a representative embodiment of a manufactured seed 20 comprising a plant embryo, a manufactured seed coat enclosing the plant somatic embryo comprising an orifice, nutritive media in functional contact with the plant embryo, and a lid sealing the plant somatic embryo within the manufactured seed. The manufactured seed also comprises a dead end seal 28, and an optional cylcap 22 (shoot restraint).

As used herein, a “manufactured seed coat” refers to a structure analogous to a natural seed coat that protects the plant embryo and other internal structures of the manufactured seed from mechanical damage, desiccation, from attack by microbes, fungi, insects, nematodes, birds, and other pathogens, herbivores, and pests, among other functions. The seed coat 24 may be fabricated from a variety of materials including, but not limited to, cellulosic materials, glass, plastic, moldable plastic, cured polymeric resins, paraffin, waxes, varnishes, and combinations thereof such as a wax-impregnated paper. The materials from which the seed coat is made are generally non-toxic and provide a degree of rigidity. The seed coat can be biodegradable, although typically the seed coat remains intact and resistant to penetration by plant pathogens until after emergence of the germinating embryo. The seed coat may be formed from a section of tubular material. The seed coat may be a sectioned straw of fibrous material, such as paper. The sections of straw may be pretreated in a suitable coating material, such as wax. Alternatively, the seed coat may be formed from a tubular section of biodegradable, plastic material. One such material is polylactic acid (“PLA”). Another suitable material is a polycaprolactone (“PCL”) mixture, such as CAPA™ (Perstorp Polyols Inc., Toledo, Ohio) with or without a 1% TEGOMER® H SI6440 plasticizer (Degussa Goldschmidt Chemical Corp, Hopewell, Va.). Such biodegradable plastic tubes may or may not require a wax coating as such tubes are already resistive to environmental elements. Additives such as antibiotics and plant-growth regulators may be added to the seed coat, for example, by incorporation into the material forming one or more of the layers of the seed coat or by coating or otherwise treating the layer(s) with the additive by conventional means.

The cylcap 22, also known as a shoot restraint, or cotyledon restraint, is suitably manufactured from a porous material having hardness strong enough to resist puncture or fracture by a germinating embryo, such as a ceramic or porcelain material, and includes an end seal portion 30 and a cotyledon restraint portion 32. The restraint portion 32 has an interior surface for contacting and surrounding at least the shoot end of a plant embryo and resists penetration by the shoot end during germination. The shoot restraint prevents the shoot end of the embryo, such as the cotyledons, from growing into and becoming entrapped in the nutritive medium (also referred to as gametophyte medium). The cotyledon restraint portion 32 is suitably integrally or unitarily formed with the end seal portion 30. The cylcap 22 also includes a longitudinally extending cavity 34 extending through the end seal portion 30 and partially through one end of cotyledon restraint portion 32. The open end of the cavity 34 is known as a cotyledon restraint opening 36. The cavity 34 is sized to receive a plant embryo 42 therein. As shown in FIG. 1, the cylcap 22 comprises a plurality of pores 27, wherein the pores 27 allow the nutritive media 26 access into the inside of the cavity 34 comprising the embryo 42, and therefore allows the nutritive media 26 to functionally contact the embryo 42 under conditions sufficient to generate a conditioned embryo, as described herein.

The restraint is porous to allow access of the embryo to water, nutrients, and oxygen. The shoot restraint may be fabricated from any suitable material, including, but not limited to, glassy, metal, elastomeric, ceramic, clay, plaster, cement, starchy, putty-like, synthetic polymeric, natural polymeric, and adhesive materials.

As further shown in FIG. 1, in some embodiments of the manufactured seed 20, fill material 80 either completely or partially surrounds the embryo 42 and increases the surface area of the embryo 42 in functional contact with the nutritive media 26, thereby providing multiple pathways for the nutrients from the nutritive media 26 to pass to the embryo 42. Although it is preferred that the fill material 80 substantially centers the embryo 42 within the cavity 34, the embryo 42 need not be so positioned. The fill material 80 need only position the embryo 42 within the cavity 34 in any manner to place the embryo 42 into functional contact with the nutritive media 26. Further, in some embodiments of the description, the fill material 80 need only fill, either completely or partially, one or two sides of the space between the embryo 42 and the walls of the cavity 34.

Preferably, the fill material 80 is an adsorbent, such as activated charcoal, Dowex resins, zeolites, alumina, clay, diatomaceous earth, silica gel, and Kieselguhr. During assembly of the manufactured seed 20, the fill material 80 is deposited into the cavity 34 of the cylcap 22 in any manner known in the art, including manually. The fill material 80 is preferably, but not necessarily, deposited within the cavity 34 such that it substantially centers the embryo 42 within the cavity 34. Centering the embryo 42 within the cavity 34 increases the surface area of the embryo 42 in functional contact with the nutritive media 26. As used herein, the term “functional contact” is intended to mean in a position where the embryo 42 uptakes nutrients from the nutritive media 26.

In some embodiments, the fill material 80 is charcoal. Preferably, the charcoal is in the form of a powder and is activated by pretreatment with an acid such as HCl, or phosphoric acid. Activated charcoal is commercially available. For example, powdered activated carbon NORIT® CNSP or DARCO® KB-G are produced by chemical activation using a phosphoric acid process and are available from Norit Americas Inc., Marshall, Tex.

In some embodiments, the fill material 80 is nutrient-treated charcoal. As used herein, the term “nutrient-treated” charcoal refers to charcoal that has been in contact with media that contains a variety of nutrients, such as a carbon source, vitamins, minerals, and amino acids, so that the charcoal absorbs and retains nutrients from the media. A representative media used to prepare nutrient-treated charcoal is media KE64, as described in Example 1. An exemplary method for preparing nutrient-treated charcoal for use as a fill material 80 for insertion into the cavity 34 is provided in Example 1.

In accordance with the manufactured seeds and methods described herein, nutritive media 26 (otherwise referred to as “gametophyte medium”) is in functional contact with the plant embryo disposed within the manufactured seed 20. As used herein, a “nutritive medium” refers to a source of nutrients, such as vitamins, minerals, carbon, and energy sources, and other beneficial compounds used by the embryo during germination. Thus, the nutritive medium is analogous to the gametophyte of a natural seed.

The methods of the present description are useful to prepare improved nutritive medium comprising a plant non-metabolizable sugar for use in the growth and/or germination of plant embryos. The non-metabolizable sugar may be selected from the group consisting of turanose, isomaltulose, lactulose, 3α-galactobiose, lactitol, lactose, 4β-galactobiose, palatinitol, and melibiose. The improved nutritive medium generated according to the description is useful for manufacturing and germinating manufactured seeds in a variety of different contexts.

In accordance with this aspect of the description, a first nutritive media comprising a pre-determined initial concentration of components comprising one or more carbon sources, vitamins, minerals and amino acids, and a plant non-metabolizable sugar.

Suitable adsorbent materials for use in the methods of making a modified (or improved) nutritive media include, but are not limited to, charcoal, polyvinyl polypyrolidone, and silica gels. In some embodiments, the adsorbent material in the first and modified (improved) nutrient media is from 1.0 g/l to 100 g/l charcoal. In some embodiments, the charcoal added to the first and modified (improved) nutritive media is from 1.0 g/l to 100 g/l of non-nutrient-treated charcoal (such as, for example, from 5 g/l, 20 g/l to 100 g/l, from 50 g/l to 100 g/l, from 60 g/l to 100 g/l, or from 50 g/l to 80 g/l, or about 60 g/l).

In accordance with this aspect of the description, the first and modified (improved) nutritive media includes a plant non-metabolizable sugar. The non-metabolizable sugar may be selected from the group consisting of turanose, isomaltulose, lactulose, 3α-galactobiose, lactitol, lactose, 4β-galactobiose, palatinitol, and melibiose. The concentration of a plant non-metabolizable sugar in the improved nutritive media is preferably at least 1 g/l and at most 40 g/l, most preferably between 10 g/l and 30 g/l.

In accordance with this aspect of the description, the nutritive medium comprises at least one component selected from the group consisting of NH₄NO₃, KH₂PO₄, myo-inositol, thiamine-HCL, pyridoxine-HCL, nicotinic acid, riboflavin, Ca-pantothenate, biotin and folic acid, DL-serine, L-proline, L-arginine-HCL and L-alanine.

The nutritive media also typically includes CuCl₂, CaCl₂, MgSO₄, ferric citrate, MnCl₂, H₃BO₃, ZnSO₄, and (NH₄)₂MoO₄. In some embodiments, the nutritive media includes FeSO₄ at a concentration from about 5 mg/l to about 25 mg/l, such as from about 10 mg/l to about 15 mg/l. In some embodiments, the nutritive media includes MgSO₄ at a concentration from about 600 mg/l to about 1500 mg/l, such as from about 800 mg/l to about 1200 mg/l.

The nutritive media may also comprise amino acids. Suitable amino acids may include amino acids commonly found incorporated into proteins as well as amino acids not commonly found incorporated into proteins, such as argininosuccinate, citrulline, canavanine, ornithine, and D-stereoisomers. In one embodiment, the nutritive medium also includes at least one amino acid selected from the group consisting of from 85 mg/l to 100 mg/l DL-serine; from 55 mg/l to 70 mg/l L-proline, from 300 mg/l to 600 mg/l L-arginine-HCL, and from 55 mg/l to 70 mg/l L-alanine.

The nutritive media typically further comprises one or more carbon sources, vitamins, and minerals. Suitable carbon sources include, but are not limited to, monosaccharides, disaccharides, and/or starches. As described herein, a plant non-metabolizable sugar may act as a carbon source. The modified nutritive medium may also include one or more compounds involved in nitrogen metabolism, such as urea or polyamines.

The nutritive media may include oxygen-carrying substances to enhance both the absorption of oxygen and the retention of oxygen by the nutritive medium, thereby allowing the medium to maintain a concentration of oxygen that is higher than would otherwise be present in the medium solely from the absorption of oxygen from the atmosphere. Exemplary oxygen-carrying substances include perfluorocarbons, such as FC-77, and surfactants such as Pluronic F-68, available from BASF Corp., Parsippany, N.J. Exemplary oxygen-carrying substances are described in U.S. Pat. No. 5,564,224 (e.g., Col. 9, line 44, to Col. 11, line 67), herein incorporated by reference.

The nutritive media may also contain hormones. Suitable hormones include, but are not limited to, abscisic acid, cytokinins, auxins, and gibberellins. Abscisic acid is a sesquiterpenoid plant hormone that is implicated in a variety of plant physiological processes (see, e.g., Milborrow, J. Exp. Botany 52:1145-1164 (2001); Leung & Giraudat, Ann. Rev. Plant Physiol. Plant Mol. Biol. 49:199-123 (1998)). Auxins are plant growth hormones that promote cell division and growth. Exemplary auxins for use in the germination medium include, but are not limited to, 2,4-dichlorophenoxyacetic acid, indole-3-acetic acid, indole-3-butyric acid, naphthalene acetic acid, and chlorogenic acid. Cytokinins are plant growth hormones that affect the organization of dividing cells. Exemplary cytokinins for use in the germination medium include, but are not limited to, e.g., 6-benzylaminopurine, 6-furfurylaminopurine, dihydrozeatin, zeatin, kinetin, and zeatin riboside. Gibberellins are a class of diterpenoid plant hormones (see, e.g., Krishnamoorthy (1975) Gibberellins and Plant Growth, John Wiley & Sons). Representative examples of gibberellins useful in the practice of the present description include gibberellic acid, gibberellin 3, gibberellin 4, and gibberellin 7. An example of a useful mixture of gibberellins is a mixture of gibberellin 4 and gibberellin 7 (referred to as gibberellin 4/7), such as the gibberellin 4/7 sold by Abbott Laboratories, Chicago, Ill. When abscisic acid is present in the modified nutritive medium, it is typically used at a concentration in the range of from about 1 mg/l to about 200 mg/l. When present in the nutritive medium, the concentration of gibberellin(s) is typically between about 0.1 mg/l and about 500 mg/l. Auxins may be used, for example, at a concentration of from 0.1 mg/l to 200 mg/l. Cytokinins may be used, for example, at a concentration of from 0.1 mg/l to 100 mg/l.

The nutritive media may also include antimicrobials. Suitable antimicrobials are available from Sigma-Aldrich, St. Louis, Mo. Antimicrobials may be used, for example, at a concentration of 1 ml/L.

The methods of the description also may be carried out with nutritive media that include a substance that causes the medium to be a semisolid or have a congealed consistency under normal environmental condition. For example, the nutritive medium may be in the form of a hydrated gel. A “gel” is a substance that is prepared as a colloidal solution and that will, or can be caused to, form a semisolid material. Such conversion of a liquid gel solution into a semisolid material is termed herein “curing” or “setting” of the gel. A “hydrated gel” refers to a water-containing gel. Such gels are prepared by first dissolving in water (where water serves as the solvent, or “continuous phase”) a hydrophilic polymeric substance (serving as the solute, or “disperse phase”) that, upon curing, combines with the continuous phase to form the semisolid material. Thus, the water becomes homogeneously associated with the solute molecules without experiencing any substantial separation of the continuous phase from the disperse phase. However, water molecules can be freely withdrawn from a cured hydrated gel, such as by evaporation or imbibition by a germinating embryo. When cured, these gels have the characteristic of compliant solids, like a mass of gelatin, where the compliance becomes progressively less and the gel becomes more “solid” to the touch as the relative amount of water in the gel is decreased.

In addition to being water-soluble, suitable gel solutes are neither cytotoxic nor substantially phytotoxic. As used herein, a “substantially non-phytotoxic” substance is a substance that does not interfere substantially with normal plant development, such as by killing a substantial number of plant cells, substantially altering cellular differentiation or maturation, causing mutations, disrupting a substantial number of cell membranes or substantially disrupting cellular metabolism, or substantially disrupting other process.

Candidate gel solutes include, but are not limited to, the following: sodium alginate, agar, agarose, amylose, pectin, dextran, gelatin, starch, amylopectin, modified celluloses such as methylcellulose and hydroxyethylcellulose, and polyacrylamide. Other hydrophilic gel solutes can also be used, so long as they possess similar hydration and gelation properties and lack of toxicity.

Gels are typically prepared by dissolving a gel solute, usually in fine particulate form, in water to form a gel solution. Depending upon the particular gel solute, heating is usually necessary, sometimes to boiling, before the gel solute will dissolve. Subsequent cooling will cause many gel solutions to reversibly “set” or “cure” (become gelled). Examples include gelatin, agar, and agarose. Such gel solutes are termed “reversible” because reheating cured gel will re-form the gel solution. Solutions of other gel solutes require a “complexing” agent which serves to chemically cure the gel by crosslinking gel solute molecules. For example, sodium alginate is cured by adding calcium nitrate (Ca(NO₃)₂) or salts of other divalent ions such as, but not limited to, calcium, barium, lead, copper, strontium, cadmium, zinc, nickel, cobalt, magnesium, and iron to the gel solution. Many of the gel solutes requiring complexing agents become irreversibly cured, where reheating will not re-establish the gel solution.

The concentration of gel solute required to prepare a satisfactory gel according to the present description varies depending upon the particular gel solute. For example, a useful concentration of sodium alginate is within a range of about 0.5% w/v to about 2.5% w/v, preferably about 0.9% w/v to 1.5% w/v. A useful concentration of agar is within a range of about 0.8% w/v to about 2.5% w/v, preferably about 1.8% w/v. In general, gels cured by complexing require less gel solute to form a satisfactory gel than “reversible” gels.

Through the practice of the methods of this aspect of the description, the present inventors have generated a modified (improved) nutritive medium for use in manufactured seeds, as described in Example 2.

In some embodiments, a nutritive media is provided, wherein the nutritive media comprises from 1 g/l to 40 g/l a plant non-metabolizable sugar, from 10 g/l to 100 g/l of an adsorbent material, from 350 mg/l to 450 mg/l NH₄NO₃, from 2000 mg/l to 3000 mg/l KH₂PO₄; and at least one component selected from the group consisting of: from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l of nicotinic acid, from 0.15 mg/l to 0.30 mg/l of riboflavin, from 0.75 mg/l to 2.0 mg/l of Ca-pantothenate, from 0.01 mg/l to 0.03 mg/l biotin and from 0.15 mg/l to 0.30 mg/l folic acid.

In some embodiments, the nutritive media further comprises at least one component selected from the group consisting of: from 85 mg/l to 100 mg/l DL-serine; from 55 mg/l to 70 mg/l L-proline, from 300 mg/l to 600 mg/l L-arginine-HCL, and from 55 mg/l to 70 mg/l L-alanine.

In some embodiments, the nutritive media further comprises about 60 g/l of non-nutrient-treated charcoal, from about 350 mg/l to about 375 mg/l NH₄NO₃, from about 2000 mg/l to about 2100 mg/l KH₂PO₄, and at least one component selected from the group consisting of: about 200 mg/l myo-inositol, about 2.0 mg/l thiamine-HCl, about 0.50 mg/l pyridoxine-HCl, about 2.0 mg/l nicotinic acid, about 0.26 mg/l riboflavin, about 1.0 mg/l Ca-pantothenate, about 0.02 mg/l, biotin and about 0.25 mg/l folic acid.

In accordance with another aspect of the description, a manufactured seed comprising a nutritive media comprising from 1 g/l to 30 g/l a plant non-metabolizable sugar, from 10 g/l to 100 g/l of a non-nutrient-treated adsorbent material, and from 350 mg/l to 450 mg/l NH₄NO₃, from 2000 mg/l to 3000 mg/l KH₂PO₄, and at least one component selected from the group consisting of: from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l riboflavin, from 0.75 mg/l to 2.0 mg/l Ca-pantothenate, from 0.01 mg/l to 0.03 mg/l biotin, and from 0.15 mg/l to 0.30 mg/l folic acid, provides an improvement in germination rate and normalcy of germinants in comparison to a manufactured seed comprising a conventional nutritive media (i.e., KE64) without a plant non-metabolizable sugar.

In some embodiments, the modified nutritive media for use in the manufactured seed further comprises about 60 g/l non-nutrient-treated charcoal, from about 350 mg/l to about 375 mg/l NH₄NO₃, from about 2000 mg/l to about 2100 mg/l KH₂PO₄, and at least one component selected from the group consisting of: about 200 mg/l myo-inositol, about 2.0 mg/l thiamine-HCl, about 0.50 mg/l pyridoxine-HCl, about 2.0 mg/l nicotinic acid, about 0.26 mg/l riboflavin, about 1.0 mg/l Ca-pantothenate, about 0.02 mg/l biotin, and about 0.25 mg/l folic acid.

In some embodiments, the manufactured seed further comprises a shoot restraint, wherein the shoot restraint comprises a cavity sized to receive the conifer embryo. In some embodiments, the manufactured seed further comprises a conifer embryo disposed within the cavity of the shoot restraint.

In some embodiments, the manufactured seed further comprises an adsorbent material, such as charcoal, in the cavity. In some embodiments, the charcoal in the cavity is nutrient-treated.

In one exemplary embodiment, the manufactured seed comprises a nutritive medium comprising about 1 g/l to 40 g/l a plant non-metabolizable sugar, 60 g/l non-nutrient-treated charcoal, from about 350 mg/l to about 375 mg/l NH₄NO₃, from about 2000 mg/l to about 2100 mg/l KH₂PO₄, and at least one component selected from the group consisting of: about 200 mg/l myo-inositol, about 2.0 mg/l thiamine-HCl, about 0.50 mg/l pyridoxine-HCl, about 2.0 mg/l nicotinic acid, about 0.26 mg/l of riboflavin, about 1.0 mg/l Ca-pantothenate, about 0.02 mg/l biotin, and about 0.25 mg/l folic acid.

The modified (improved) nutritive medium generated using the methods of the description and manufactured seeds comprising the modified nutritive medium may be used for germinating a conifer embryo. The method according to this aspect of the description comprises (a) placing a conifer embryo into functional contact with a nutritive media in a manufactured seed, the nutritive media comprising: from 1 g/l to 40 g/l a plant non-metabolizable sugar, from 10 g/l to 100 g/l charcoal, from 350 mg/l to 450 mg/l NH₄NO₃, from 2000 mg/l to 3000 mg/l KH₂PO₄; and at least one component selected from the group consisting of: from 150 mg/l to 300 mg/l myo-inositol, from 1.5 mg/l to 3.0 mg/l thiamine-HCl, from 0.30 mg/l to 0.80 mg/l pyridoxine-HCl, from 1.5 mg/l to 3.0 mg/l nicotinic acid, from 0.15 mg/l to 0.30 mg/l riboflavin, from 0.75 mg/l to 2.0 mg/l Ca-pantothenate, from 0.01 mg/l to 0.03 mg/l biotin and from 0.15 mg/l to 0.30 mg/l folic acid; and (b) placing the manufactured seed in an environment conducive for plant growth so as to allow the embryo to grow and germinate from the manufactured seed.

As described, supra, the present inventors have discovered, through experimentation, that a manufactured seed comprising a nutritive media with a plant non-metabolizable sugar improves the germination frequency of conifer embryos in comparison to a standard nutritive media (e.g., KE64 and MS-11). The modified nutritive media described herein in connection with the manufactured seeds is also useful in the methods for germinating an embryo. In some embodiments of the method, the charcoal in the modified nutritive media is non-nutrient treated prior to addition to the media. In some embodiments, the modified nutritive media comprises from 1 g/l to 40 g/l a plant non-metabolizable sugar. In some embodiments, the a plant non-metabolizable sugar added to the nutritive media is from 10 g/l to 30 g/l of a plant non-metabolizable sugar.

### EXAMPLES

### Example 1

This Example provides a representative method of preparation of suitable nutritive medium, nutrient-treated charcoal, and representative manufactured seeds suitable for use in the methods described herein.

Methods:

Somatic embryos: Somatic embryos of Loblolly pine genotype A were grown in liquid culture then plated on a development medium and incubated for a period of 12 weeks, followed by incubation for 4 weeks on a stratification medium at 4° C. At the end of this sequence, embryos were loaded into a manufactured seed as described below.

Manufactured Seed:

Representative methods used for making manufactured seeds are described in U.S. Pat. Nos. 8,739,463; 7,882,656; and 7,356,965, incorporated herein by reference.

Manufactured seeds were prepared with KE 64 agar nutritive medium, as shown below in Table 1, with sucrose (50 g/L), agar (18 g/L to 26 g/L), nutrient-loaded charcoal (60 g/L) and Pluronic F68 (10 g/L).

The manufactured seeds used in this Example included a seed coat 24, nutritive medium and a plant embryo 42. Nutritive medium is analogous to the gametophyte of a natural seed. A manufactured seed that does not include the plant embryo is known in the art as a “seed blank.” The seed blank typically is a cylindrical capsule having a closed end and an open end. The synthetic gametophyte is placed within the seed coat to substantially fill the interior of the seed coat. A longitudinally extending hard porous insert, known as a cotyledon restraint 22, was centrally located within one end of the seed coat, surrounded by the synthetic gametophyte, and included a centrally located cavity extending partially through the length of the cotyledon restraint.

The cavity 34 was sized to receive the plant embryo 42 therein. The well-known plant embryo includes a radicle end and a cotyledon end. The plant embryo was deposited within the cavity of the cotyledon restraint 22, cotyledon end first. The plant embryo was then sealed within the seed blank by an end seal 43. There was a weakened spot in the end seal 43 to allow the radicle end of the plant embryo to penetrate the end seal.

The end seal 43 (lid) was attached to the manufactured seed by stretching a wax base film, such as PARAFILM™ (Pechiney Plastic Packaging, Chicago, Ill.). Alternatively, the end seal may be attached to the manufactured seed by forming a wax seal to enclose the embryo within the manufactured seed. Additionally, to protect against microbial invasion, the end seals were treated with a tribiotic ointment.

The nutritive medium KE 64 (see Table 1) was prepared from pre-made stocks. The required amount of each stock solution (that is not heat-labile) was added to water. Nonstock chemicals (such as charcoal, and agar) were weighed out and added directly to the solution. After all the nonheat-labile chemicals and compounds were added, the medium was brought up to an appropriate volume and the pH was adjusted. The medium was then sterilized by autoclaving. Filter-sterilized heat-labile components (such as sucrose, amino acids, and vitamins) were added after the medium had cooled.

With reference to FIG. 1, fill material 80 for insertion into the cavity 34 of the manufactured seed was prepared by combining approximately 7.0 g of activated charcoal with 246 ml of nutritive media (KE64 Basic Media) to create a mixture. The formulation of KE64 nutritive media is provided below in Table 1.1.

TABLE 1.1
Formulation of KE64 Basic Media.

| Media component | Concentration, mg/l |
|---|---|
| NH₄NO₃ | 301.1 |
| H₃BO₃ | 10.0 |
| (NH₄)₂MoO₄ | 0.06 |
| CaCl₂—2H₂O | 299.2 |
| KH₂PO₄ | 1800.0 |
| MgSO₄—7H₂O | 1000.0 |
| MnCl₂•4H₂O | 6.0 |
| ZnSO₄—7H₂O | 0.8 |
| CuCl₂—2H₂O | 0.5 |
| Ferrous Sulfate | 13.93 |
| Sodium EDTA | 18.63 |
| Pluronic F-68 | 10,000 |
| Agar | 18,000-28,000 |

The mineral stocks were added to the KE64 media, the mixture was autoclaved for about 25 minutes, then the sucrose solution (30 ml of a 50% stock solution) and organic stocks were added to the mixture. One such organic stock formulation is provided below in Table 1.2.

The mixture was filtered through well-known filter paper and the fill material 80 (e.g., charcoal) was harvested from the filter paper. The harvested fill material 80 was then dried until it became flowable matter. The dry, nutrient loaded charcoal fill material was loaded into the restraint and the embryo was inserted into the charcoal filled area. Live ends were dipped in a blue wax mixture to provide a light coating between the primary and secondary end seals to promote good lid bonding. All seeds were lidded following insertion/charcoaling.

TABLE 1.2
Components added to KE64 Basic Media

| | Final Concentration | Final Concentration, |
|---|---|---|
| Medium Component | mM | mg/l |
| Myo-inositol | 0.5549 | 100.0 |
| Thiamine-HCl | 0.0030 | 1.0 |
| Pyridoxine-HCl | 0.0012 | 0.25 |
| Nicotinic acid | 0.0081 | 1.0 |
| Riboflavin | 0.0021 | 0.125 |
| Ca-pantothenate | | 0.50 |
| Biotin | 0.0003 | 0.0010 |
| Folic acid | 0.8077 | 0.1250 |
| L-asparagine | 1.8255 | 106.7 |
| L-glutamine | 0.3646 | 266.7 |
| L-lysine-2HCl | 0.7612 | 53.3 |
| DL-serine | 0.4631 | 80 |
| L-proline | 1.5310 | 53.3 |
| L-arginine-HCl | 0.4552 | 266.7 |
| Urea | 13.3200 | 800 |
| L-valine | 0.5983 | 53.3 |
| L-alanine | 0.2203 | 53.3 |
| L-leucine | 0.2448 | 80 |
| L-threonine | 0.3226 | 26.7 |
| L-phenylalanine | 0.1720 | 53.3 |
| L-histidine | 0.1308 | 26.7 |
| L-isoleucine | 1.2930 | 26.7 |
| L-methionine | 0.7100 | 26.7 |
| L-glycine | 0.0003 | 53.3 |
| L-tyrosine | 0.2242 | 53.3 |
| L-cysteine | 0.6098 | 26.7 |
| Sucrose | | 50,000 |
| Gibberillic Acid (GA_{4/7}) | | 0.1 |
| Antimicrobials | | 1.0 |

Several parameters may be measured to determine the germination frequency of the manufactured seeds and the quality of the germinants.

At a designated time after sowing, the lengths of the radicle, hypocotyl, cotyledons, and epicotyl of the germinants may be measured.

The term “radicle” refers to the part of a plant embryo that develops into the primary root of the resulting plant.

The term “cotyledon” refers generally to the first, first pair, or first whorl (depending on the plant type) of leaf-like structures on the plant embryo that function primarily to make food compounds in the seed available to the developing embryo, but in some cases act as food storage or photosynthetic structures.

The term “hypocotyl” refers to the portion of a plant embryo or seedling located below the cotyledons but above the radicle.

The term “epicotyl” refers to the portion of the seedling stem that is above the cotyledons.

The germination rate may be measured and the normalcy of the germinants may also be assessed. A “normal germinant” or “normalcy” denotes the presence of all expected parts of a plant at time of evaluation. In the case of gymnosperms, normalcy is characterized by the radicle having a length greater than 3 mm and no visibly discernable malformations compared to the appearance of embryos germinated from natural seed. “Not normal” means tissue on at least one organ is swollen, and the root and cotyledons are dead. “Not-normal fully extracted” means the germinant has fully emerged from the cavity but is not normal. “Unchanged” means embryo has not changed from day one of the experiment (i.e., no germination has occurred).

### Example 2

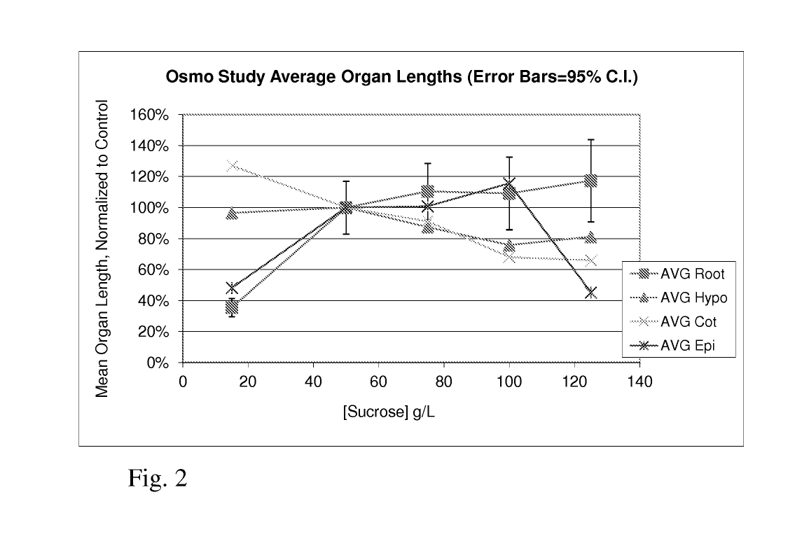

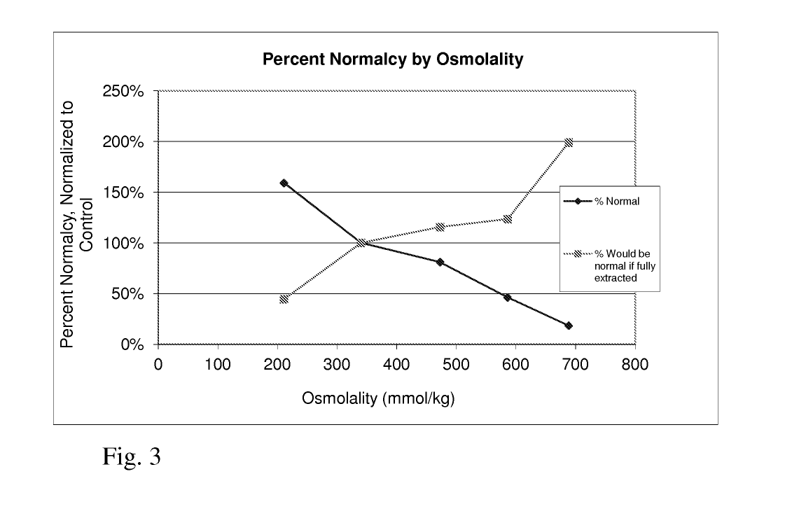

Higher water potential with relation to lower sucrose levels (solute concentration) was previously purported to increase flooding in gametophyte seed cavities. Data showed that lower sucrose concentrations improved early germination vigor in the developing embryo, but it came at the cost of root length (FIG. 2). Because of the flooding problem, this study could have selected for those treatments that had the most rapid lid penetration, which would allow embryos to escape the flooded seed environment. Incidence of normalcy was inversely proportional to sucrose concentration including the 50 g/l sucrose treatment which suggested that perhaps a lower sucrose level was appropriate (FIG. 3). Subsequent studies have shown that concentrations between 30 and 50 g/l perform better than lower concentrations for both root length and normalcy which suggests that the ideal sucrose level lies in that range.

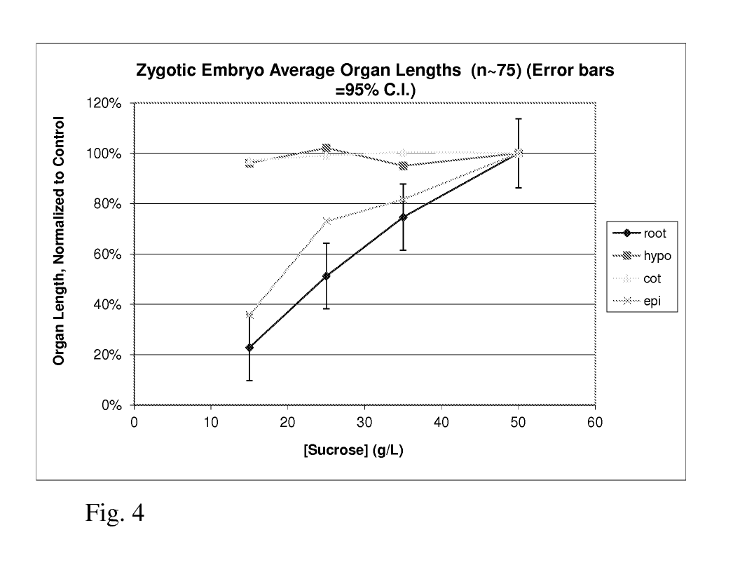

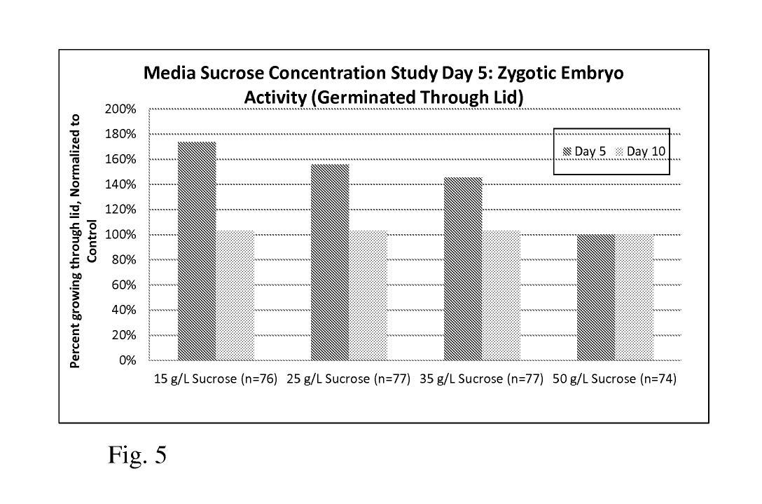

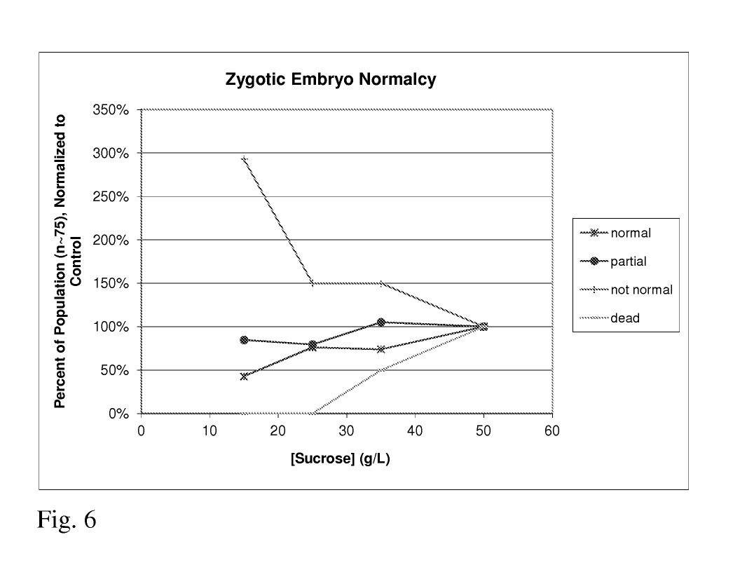

Lower sucrose concentrations (15, 25, 35 and 50 g/l) were tested as a means to improve overall kinetic activity in embryos. Organ lengths were also a factor with relation to sucrose concentrations. It was hypothesized that lower sucrose concentrations would affect root lengths and indeed the lower sucrose treatments produced shorter root lengths as compared to the highest group 50 g/l sucrose (FIG. 4). The hypothesis that a lower sucrose concentration improves kinetic activity was supported by visual scores up to day 10 (FIG. 5). After observing sufficient lid penetration, seed were transferred from boxes to sterile sand. Following germination in sand, data showed that greater normalcy was associated with higher sucrose concentrations (FIG. 6).

Previous data suggests complex effects of sucrose levels on organ length and germination. Roots utilize sucrose as a carbon source and thus improve their length when it is abundant. With adequate carbon being supplied from the gametophyte, hypocotyl and cotyledon organ lengths are sometimes slightly shorter because demand for photosynthesis is less. Conversely, in seed with lower sucrose concentrations, osmotic potential of the medium would be less negative, making nutrients and water initially more available to the embryos in the cavity. This could boost early performance, but activity would likely be surpassed by higher sucrose treatments once nutrients became available to them. Embryos that do not receive adequate carbon from the gametophyte tend to grow longer cotyledons and hypocotyls related to the increased demand for photosynthesis to supplement carbon demand.

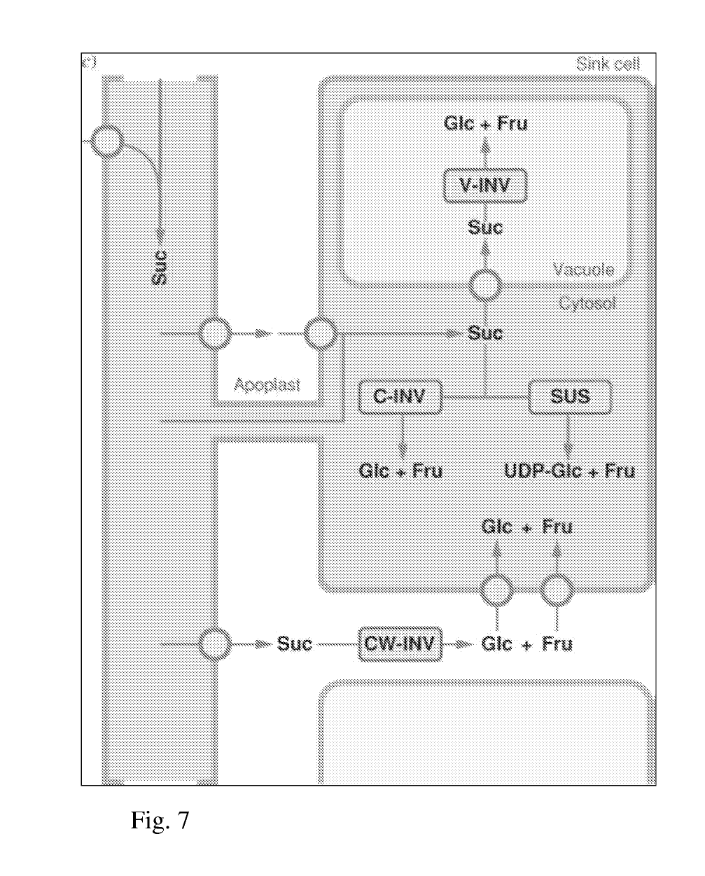

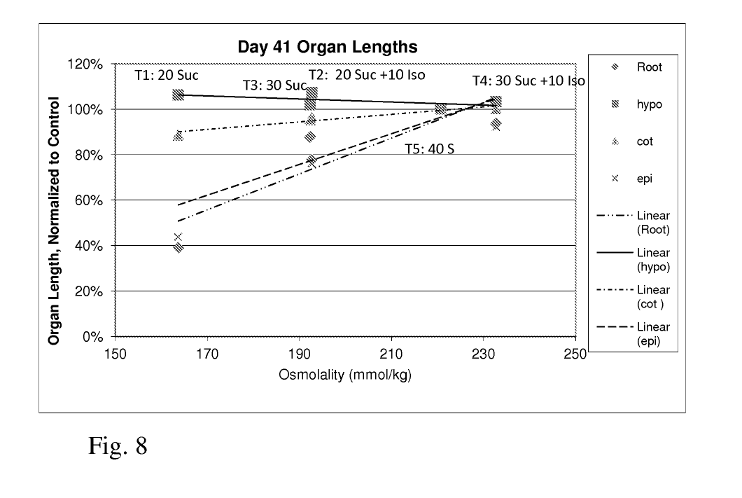

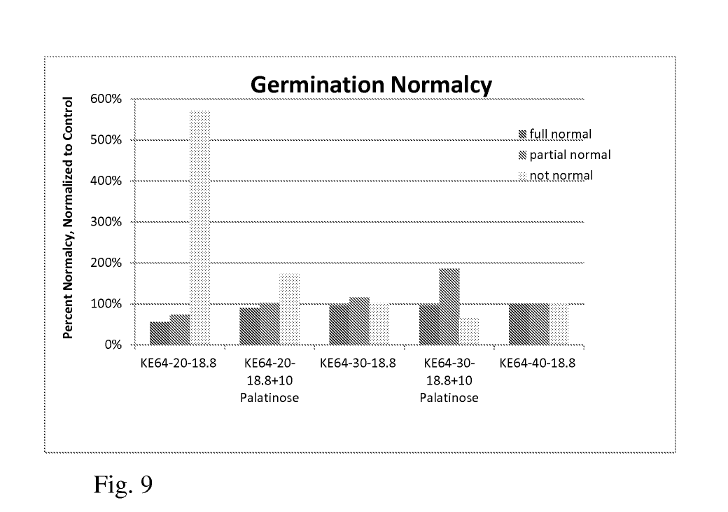

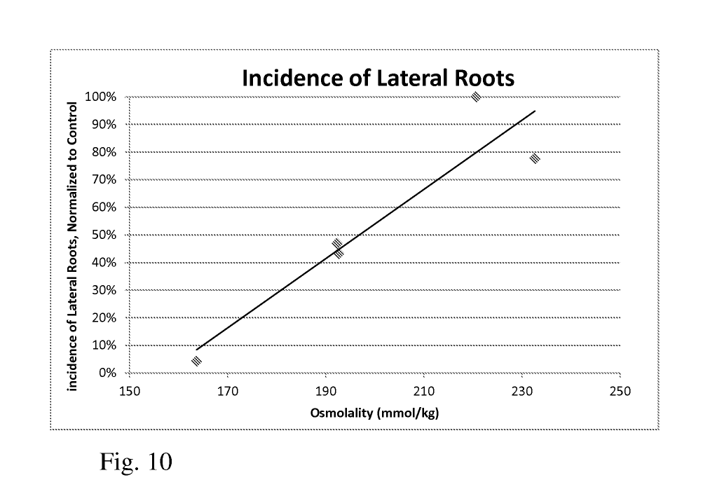

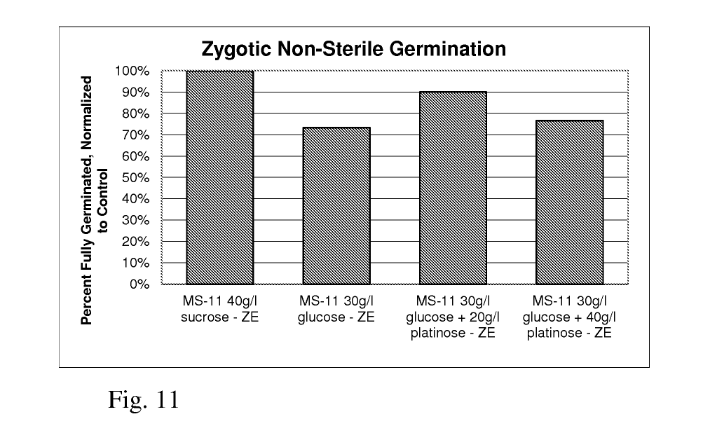

Sucrose uptake into plant tissue can occur through several routes including symplastic, trans-cell membrane and trans-vacuolar membrane transport either as sucrose or as components glucose and fructose (Rolland et al., 2006, Ann Rev Plant Biol 57:675-709) (FIG. 7). Transporters to facilitate sugar-specific uptake and metabolism include sucrose-P synthase, sucrose-P phosphatase; ADP-glc pyrophosphorylase; UDP-glucose pyrophosphorylase; invertase in the cytosol, the cell wall, vacuoles; sucrose synthase (id.). The role of invertase (β-fructofuranosidase) at the locations is to catalyze the hydrolysis of sucrose into glucose+fructose, which can be further transformed into pyruvate for the citric acid cycle or stored as starch. However, many plants lack the enzymes to metabolize certain sugars (Gibson, 2000, Plant Physiol 124:1532-39), making some sugars ideal for balancing osmotic potential in sugar treatments since they are not readily absorbed.

The availability of carbon provided by the sugar was compared without changing the osmolality of the medium. Use of a non-metabolizable sugar could boost the osmolality without adding additional carbon availability to the plant. In addition, the effect of similar osmolality was compared with different carbon availability with respect to germination and organ lengths.

The effects of increased osmolality were distinguished from increased carbon availability associated with sucrose addition. Isomaltulose (metabolically unavailable to most plants) was used to equalize osmolality with treatments containing more sucrose. Treatments included the following:
1. 20 g/l sucrose (“20 sucrose”)
2. 20 g/l sucrose+10 g/l isomaltulose (“20 sucrose+10 isomaltulose”)
3. 30 g/l sucrose (“30 sucrose”)
4. 30 g/l sucrose+10 g/l isomaltulose (“30 sucrose+10 isomaltulose”)
5. 40 g/l sucrose (“40 sucrose”)

Seeds were prepared and tested as in Example 1. Higher solute concentration reduced early germination kinetics (20 sucrose vs. 20 sucrose+10 isomaltulose; 30 sucrose vs. 30 sucrose+10 isomaltulose).

Effects of Isomaltulose

The results show that higher solute concentration did not reduce early germination kinetics. Results support that treatments benefit from greater sucrose amounts in media up to the maximum tested in this study (Table 2.1). It was surprising that 20 sucrose+10 isomaltulose performed better than 20 sucrose. The increased performance was equivalent to the 30 sucrose treatment in early activity.

TABLE 2.1
Visual Scores Relative to media with 20 sucrose

| treatment | above | partial | Below | root up |
|---|---|---|---|---|
| 20 sucrose | 1.0 | 1.0 | 1.0 | 1.0 |
| 20 sucrose + 10 isomaltulose | 1.3 | 0.67 | 0.91 | 0.64 |
| 30 sucrose | 1.4 | 0.59 | 1.0 | 0 |
| 30 sucrose + 10 isomaltulose | 1.4 | 0.66 | 0 | 0 |
| 40 sucrose | 1.4 | 0.54 | 0 | 0.91 |
| P value | 0.0995 | 0.0683 | 0.7677 | 0.3192 |

Increase in Metabolizable Carbon Improves Germination for the Same Osmolality

The results also showed that increases in metabolizable carbon improve germination for the same osmolality (20 sucrose+10 isomaltulose vs. 30 sucrose; and 30 sucrose+10 isomaltulose vs. 40 sucrose) (FIG. 8, Table 2.2). Root lengths for 20 sucrose were significantly shorter than all others, suggesting that 20 g/l sucrose with no isomaltulose addition was not sufficient for best root performance. Media with 20 sucrose and media with 20 sucrose+10 isomaltulose had the same amount of metabolizable carbon. 20 sucrose+10 isomaltulose, however, performed significantly better than the media with 20 sucrose but was not significantly different compared with 30 sucrose having the same osmolality, 30 sucrose+10 isomaltulose, or 40 sucrose. Small differences among 20 sucrose+10 isomaltulose, 30 sucrose, 30 sucrose+10 isomaltulose, and 40 sucrose showed increased root length with sucrose concentration.

TABLE 2.2
Organ Lengths relative to media with 20 sucrose (α = 0.05)

| treatment | Root | hypocotyl | cotyledon | epicotyl |
|---|---|---|---|---|
| 20 sucrose | 1.00 | 1.00 | 1.00 | 1.00 |
| 20 sucrose + 10 isomaltulose | 1.98 | 1.01 | 1.09 | 1.73 |
| 30 sucrose | 2.24 | 0.961 | 1.08 | 2.31 |
| 30 sucrose + 10 isomaltulose | 2.40 | 0.974 | 1.13 | 2.09 |
| 40 sucrose | 2.56 | 0.942 | 1.12 | 2.27 |
| P value | <0.0001 | 0.268 | 0.1797 | <0.0001 |

Similar to root length above, normalcy showed the same trend. Treatment with 20 sucrose had significantly lower incidence of normal germination compared with 20 sucrose+10 isomaltulose, 30 sucrose, 30 sucrose+10 isomaltulose, and 40 sucrose, which were not significantly different from one another (FIG. 9, Table 2.3). Though a treatment with 20 sucrose+10 isomaltulose did not quite have as high of normalcy, it was clearly an improvement over the 20 g/l treatment.

TABLE 2.3
Normalcy, relative to 20 sucrose

| treatment | full normal | partial normal | not normal |
|---|---|---|---|
| 20 sucrose | 1.0 | 1.0 | 1.0 |
| 20 sucrose + 10 isomaltulose | 1.6 | 1.4 | 0.31 |
| 30 sucrose | 1.7 | 1.6 | 0.19 |
| 30 sucrose + 10 isomaltulose | 1.7 | 2.6 | 0.13 |
| 40 sucrose | 1.8 | 1.4 | 0.17 |
| P value | 0.0023 | 0.7933 | <0.0001 |

Another observation was the incidence of lateral roots. These data show 20 sucrose with the lowest percentage, 20 sucrose+10 isomaltulose and 30 sucrose nearly equal, and 30 sucrose+10 isomaltulose closer to 40 sucrose (FIG. 10, Table 2.4). Performance similarities were not strictly according to useable carbon as was expected, but rather showed that isomaltulose played some other role in improving performance.

TABLE 2.4
Lateral Roots, relative to 20 sucrose

| Treatment | lateral roots |
|---|---|
| 20 sucrose | 1.0 |
| 20 sucrose + 10 isomaltulose | 10 |
| 30 sucrose | 11 |
| 30 sucrose + 10 isomaltulose | 18 |
| 40 sucrose | 23 |
| P value | <0.001 |

Embryo vigor and root competence remain common and particularly challenging issues that reduce germination from somatic embryos across many species. One approach to improving both properties involves modification of the gametophyte medium sugar content and optimal osmotic potential within the manufactured seed construct. Sugar remains the primary carbon source within manufactured seed, so embryos situated within the cotyledon restraint rely on osmotic gradients, mass flow, and matric potential for delivery.

Increased sugar content in the gametophyte proportionally affects osmotic potential so the two become confounded if one simply increases sugar content. Isomaltulose has been reported to be a non-plant-metabolizable sugar (Loreti et al., 2000; Fernie et al., 2001). Isomaltulose is considered non-metabolizable because neither sucrose transporters nor extracellular invertase enzymes recognize it in plants (Fernie et al., 2001). Isomaltulose also serves as a good proxy for sucrose because both sugars contain a glucose and fructose moiety, share identical molecular weight, and isomaltulose only differs structurally in its 1-6 carbon linkage between the respective monosaccharides where sucrose links at the 1-2 carbons.

For the purposes of this description, the media naming convention lists the basal medium followed by the sugar amount in g/l and the type (e.g. KE64-30 sucrose contains KE64 basal medium with 30 g/l sucrose). The first test of isomaltulose in manufactured seed used an approach in which carbon and osmotic potential were matched using proportionally increasing amounts of sucrose and isomaltulose.

The study used embryos dissected from natural loblolly pine seed to test responses. This study produced unexpected results because data showed that addition of 10 g/l isomaltulose significantly increased root and epicotyl lengths (Table 2.2), germinant normalcy (a measure of germination extraction success) (Table 2.3), and lateral root presence, when compared to the same treatment without isomaltulose (Table 2.4). This suggests that isomaltulose improved performance even with adequate sucrose levels in the gametophyte medium. Both root length and epicotyl length increased significantly with isomaltulose addition to a 20 sucrose medium. No improvement in organ lengths were seen when isomaltulose was added to 30 sucrose. Treatment with 20 sucrose+10 isomaltulose increased normalcy performance significantly, compared to 20 sucrose. No additional significant effect was seen from 30 sucrose+10 isomaltulose.

Isomaltulose significantly improved lateral root presence in both treatments compared to their sucrose controls. Data suggest that isomaltulose provides a benefit even at sufficient sucrose levels in the gametophyte medium.

The results suggested that exogenous isomaltulose addition could provide a novel way to induce signaling that benefits embryo germination. While plants generally cannot metabolize isomaltulose, literature shows that plants likely perceive it at the plasma membrane level (Loreti et al., 2000). The published effects of isomaltulose treatment on plant cells include: increased invertase enzyme activity (Sinha, et al., 2002), sucrose synthase inhibition (Fernie et al., 2001), and α-amylase repression leading to increased starch storage (Loreti et al., 2000; Fernie at al., 2001). However, the signaling mechanisms and metabolic effects on germinating conifer embryos are unclear.

Previous studies showed that sucrose levels around 15 to 20 g/l underperformed compared to 35 to 40 g/l. However, isomaltulose addition caused a clear improvement in normalcy and root length. One possible explanation for the improvement could be the role of isomaltulose as a signaling molecule. Fernie et al., 2001, shows an increase in invertase activity and starch synthesis with the addition of isomaltulose to cut potato tubers. In addition, isomaltulose was only poorly absorbed into the tissue and not metabolized, suggesting that the signal was sent through receptors in the plasma membrane. Invertase activity peaked with the addition of 50 mM and 20 mM isomaltulose for alkaline and acid invertases respectively. The results reported above used 10 g/l isomaltulose, which falls within the putative peak signal efficacy ranges seen in the work by Fernie et al.

Aside from the signaling evidence from the literature, the effect of isomaltulose is not thought to be simply from additional osmoticant because higher osmolality medium would drive the water potential gradient further in the direction of the gametophyte, not toward the embryo. In addition, treatments in another study using glucose+fructose instead of sucrose (both at equal carbon and equal osmotic levels) had much slower germination and lower normalcy than the standard sucrose treatment, suggesting that increased osmolality was not beneficial in a manufactured seed environment. A study testing increased arginine also found that greater arginine was not beneficial, and actually reduced performance at higher levels, providing evidence that increased gametophyte osmolality is not necessarily beneficial.

Reports describing isomaltulose signaling are rare but reports observing sucrose signaling are more abundant and demonstrate that sugars act in more ways than a carbon source. Studies show that barley embryos and carrot somatic embryos remain static in cultures containing 145 mM sucrose (or ≧5%) (Mills, et al., 1978, Ann Bot 43:559-69; Yang, et al., 2004, Plant Molec Bio 54:441-59) and 6% (Guan, et al., 2009, Plan Journal 60: 207-17). Sorbitol and other monosaccharides at the same concentration did not produce the inhibition (Yang et al., 2004) demonstrating that sucrose signaling rather than osmotic stress was involved. In addition they showed that hexokinase inhibitors had no effect on sucrose signaling, suggesting that signaling occurred independently of the hexokinase pathway. Yang et al. identified a sucrose transporter gene (cSUT) that showed a marked increase in expression at the beginning of somatic embryo germination which suggested the possibility that cSUT plays a role in sucrose signal regulation.

Additional research on somatic carrot embryos showed a sucrose signaling connection with abscisic acid (ABA) synthesis. Addition of fluridone (ABA biosynthesis inhibitor) to a 6% sucrose medium resulted in normal growth compared to the arrested growth of embryos in the same medium without fluridone (Guan, et al., 2009). Guan et al. also identified a trans-acting factor in the ABA signaling pathway (CAREB1) that was reduced with the application of fluridone, further supporting a connection with ABA synthesis. Their results suggested that high sucrose concentration retarded development of somatic carrot embryos through the ABA signal transduction pathway.

At 40 g/l (116 mM) to 50 g/l (146 mM) in manufactured seed artificial megagametophyte for loblolly pine, reduced or halted germination can be expected based on the above work with other species. One explanation for this result could be that conifers have a different level of sensitivity to sucrose signals during early germination compared to the monocots discussed in the literature. In many conifers, literature shows that sucrose is the primary form of carbon taken from the megagametophyte during germination (Ching, 1966, Plant Physiol. 41:1313-19; Kao, 1973, For Sci 19:297-302)

In light of the growing number of reports on sugar signaling, it is difficult to be certain that a particular sugar is non-metabolizable, excluded from transport across membranes, and inert as a signal molecule. Additional results were obtained from the following: 20 g/l sucrose vs. 20 g/l sucrose+10 g/l isomaltulose vs. 20 g/l sucrose+10 g/l equivalent of non-metabolizable, non-signaling osmoticant, could help separate the effect of osmotic contribution from signaling.

These results showed that 20 g/l sucrose plus 10 g/l isomaltulose in the gametophyte media provided an improvement to organ length and normalcy compared to a treatment with just 20 g/l sucrose. The response raised questions about the role of isomaltulose as an osmoticant and/or signaling molecule. Literature suggests that in potato, isomaltulose was not metabolically active but could function as a signaling molecule to increase invertase activity and starch storage. The benefit of isomaltulose addition gave zygotic pine in manufactured seed performance characteristics similar to a 30 g/l sucrose treatment, suggesting an equivalent improvement of 10 g/l sucrose availability. No significant differences were seen among treatments of 20 g/l sucrose+10 isomaltulose, 30 g/l sucrose, 30 g/l sucrose+10 isomaltulose, and 40 g/l sucrose which could indicate a threshold at 20-30 g/l sucrose in which additional amounts of isomaltulose were not beneficial or the metabolic machinery were saturated when sucrose was more abundant.

### Example 3

Using glucose instead of sucrose as a carbohydrate source was studied in the embryo germination stage. The effects of increasing glucose levels as a main carbohydrate source were measured. Initial data showed that media with 30 g/l glucose performed best. The test used the same concentration of glucose, but separately measured the osmolality variable. Isomaltulose, a non-metabolizable sugar, was used as the osmotic adjuster.

The effects of media changes were compared to manufactured seed gametophyte medium using 40 g/l sucrose as a carbohydrate source. Sucrose is a disaccharide composed of the monosaccharides fructose and glucose. Glucose is produced by plants during photosynthesis and is the main fuel for cellular respiration. Using glucose as the main carbohydrate source in seed media could reallocate energy the plant uses to break down the sucrose into other functions for growth.

The test media are described above in Example 1. The effects of nutrients and osmolality were separately measured in manufactured seed gametophyte medium. It was expected that increasing osmolality in the manufactured seed gametophyte medium would improve seedling establishment, and the osmolality change would offset any benefit from isomaltulose. Alternatively, isomaltulose could cause unknown effects on germination. Higher osmolality in the gametophyte could encourage somatic germinants to protect against water loss, and thereby improve seedling establishment, as measured by increased normalcy and/or organ lengths. However, unlike sucrose which requires enzymatic hydrolysis, glucose could require less energy to metabolize, potentially making it more accessible to microbes, and possibly leading to more contamination in a non-sterile environment.

Media with the following additives were tested:
T1 116.86 mM 40 g/l Sucrose (305 mmol/kg) (“40 sucrose”)
T2 166.52 mM 30 g/l Glucose (368 mmol/kg) (“30 glucose”)
T3 166.52 mM 30 g/l Glucose+58.42 mM 20 g/l isomaltulose (433 mmol/kg) (“30 glucose+20 isomaltulose”)
T4 166.52 mM 30 g/l Glucose+116.86 mM 40 g/l isomaltulose (505 mmol/kg) (“30 glucose+40 isomaltulose”)
The osmolality of each media is shown in Table 3.1

TABLE 3.1

| Treatment, Sugar (g/l) | Average Osmolality (Osm/L) |
|---|---|
| 40 sucrose | 305 |
| 30 glucose | 368 |
| 30 glucose + 20 isomaltulose | 433 |
| 30 glucose + 40 isomaltulose | 505 |

Seeds were prepared and tested as in Example 1.

The results described in Example 2 were derived from vigorous zygotic loblolly pine embryos which could respond differently from somatic embryos so the following studies tested isomaltulose treatments on somatic loblolly pine embryos. Results from the sterile sand portion of this example showed similar responses and confirmed that isomaltulose addition to somatic loblolly pine embryos caused significant improvements to root and epicotyl length (Table 3.2), normalcy (Table 3.4), and root presence (Table 3.5) when compared with the control.

TABLE 3.2
Somatic Organ Lengths 40 days after sowing, relative to 40 sucrose

| | Radical | | Hypocotyl | | Cotyledon | Epicotyl | |
|---|---|---|---|---|---|---|---|
| | Length (mm) | | Length (mm) | | Length (mm) | Length (mm) | |
| Treatment | p = 0.0004 | | p = <0.0001 | | p = 0.1667 | p = 0.0172 | |
| 40 sucrose | 1.0 | AB | 1.0 | A | 1.0 | 1.0 | A |
| 30 glucose | 0.61 | B | 0.98 | A | 0.89 | 0.73 | B |
| 30 glucose + | 1.1 | A | 0.91 | AB | 0.94 | 0.98 | A |
| 20 | | | | | | | |
| isomaltulose | | | | | | | |
| 30 glucose + | 1.4 | A | 0.84 | B | 0.93 | 1.1 | A |
| 40 | | | | | | | |
| isomaltulose | | | | | | | |

n value per treatment = 108;
*p-value does not include bare embryo

Using glucose alone as a carbon source significantly decreased epicotyl lengths. However, the addition of isomaltulose to glucose significantly increased root and epicotyl lengths matching germination of sucrose treatment. The purpose of isomaltulose was to increase osmolality while keeping the sugar concentration constant. Literature suggests the addition of isomaltulose could encourage germination through increased invertase activity to import sugar, and increase starch storage (Fernie et al., 2001).

TABLE 3.3
Somatic Total activity 40 days after sowing, relative to 40 sucrose

| | Full | Partial | Below | Upside |
|---|---|---|---|---|
| | Germination | Germination | Soil | Down |
| Treatment | p = 0.6281 | p = 0.1657 | p = 0.3731 | p = 0.7689 |
| 40 sucrose | 1.0 | 1.0 | 1.0 | 1.0 |
| 30 glucose | 1.0 | 0.77 | 1.5 | 1.1 |
| 30 glucose + | 0.78 | 1.1 | 1.0 | 0.91 |
| 20 isomaltulose | | | | |
| 30 glucose + | 0.58 | 1.0 | 1.3 | 0.92 |
| 40 isomaltulose | | | | |

n value per treatment = 108

No significant differences or trends were detected in any of these categories.

TABLE 3.4
Somatic Normalcy categories 40 days after sowing, relative to 40 sucrose

| | | | Partial | Normal + | | | |
|---|---|---|---|---|---|---|---|
| | Normal | | Normal | Partial | Not Normal | | Unchanged |
| Treatment | p = 0.0300 | | p = 0.1093 | Normal | p = 0.0276 | | p = 0.5967 |
| 40 sucrose | 1.00 | AB | 1.00 | 1.00 | 1.00 | AB | 0.0 |
| 30 glucose | 0.40 | A | 0.50 | 0.454 | 1.23 | B | 0.9 |
| 30 glucose + | 1.13 | B | 1.00 | 1.05 | 0.987 | A | 0.9 |
| 20 isomaltulose | | | | | | | |
| 30 glucose + | 0.81 | AB | 1.33 | 1.09 | 0.985 | A | 0.0 |
| 40 isomaltulose | | | | | | | |

n value per treatment = 108

Glucose as the only sugar source negatively affected normalcy. However, the isomaltulose/glucose combination restored normalcy such that it was not significantly different from the control (40 sucrose).

TABLE 3.5
Presence of Root, Epicotyl and Lateral in somatics
40 days after sowing, relative to 40 sucrose

| | Root Presence | | Epicotyl Presence | Lateral Presence |
|---|---|---|---|---|
| Treatment | p = 0.0172 | | p = 0.2056 | p = 0.0956 |
| 40 sucrose | 1.00 | A | 1.00 | 1.0 |
| 30 glucose | 0.650 | B | 0.586 | 0.47 |
| 30 glucose + | 1.00 | A | 1.25 | 2.4 |
| 20 isomaltulose | | | | |
| 30 glucose + | 1.05 | A | 0.928 | 3.5 |
| 40 isomaltulose | | | | |

n value per treatment = 108;
*p-value does not include bare embryo

The isomaltulose/glucose combination significantly improved root presence over glucose alone and equaled sucrose germination in sterile sand. Although lateral root presence was not significantly different α=0.05, it should be noted that the presence of lateral roots was higher in the isomaltulose treatments even outperforming the sucrose treatment.

In non-sterile soil, results did not support the hypothesis that increased osmotic potential of the seed media improved germination over the control. Similarly, germination of zygotic embryos in non-sterile soil showed no clear improvements with a higher osmotic potential compared to the control (FIG. 11). However, there was also no increase in contamination with glucose treatments. The use of glucose as the only carbon source in the gametophyte medium is not supported. However, when combined with isomaltulose it performs equal to or better than sucrose in the sterile sand such that the combination showed benefits.

### Example 4

An additional study with somatic loblolly pine embryos used media with either sucrose or glucose as the carbon source to determine if isomaltulose primarily affected invertase activity and associated trans-membrane sugar uptake. Such a mechanism would not act on glucose because of its monosaccharide status.

The results showed improvements with both sucrose and glucose-based media, suggesting that the isomaltulose benefit acted in other ways than increasing extracellular invertase activity because invertase does not act on glucose. Results suggested treatment improvements with respect to organ length (Table 4.1), normalcy (Table 4.2), and root presence (Table 4.3).

TABLE 4.1
Somatic loblolly pine organ lengths, relative to 40 sucrose

| | Radical | Epicotyl |
|---|---|---|
| | Length (mm) | Length (mm) |
| | p = 0.2172 | p = 0.3698 |
| 40 sucrose | 1.00 | 1.0 |
| 40 sucrose + 20 isomaltulose | 1.36 | 1.1 |
| 40 sucrose + 40 isomaltulose | 1.11 | 0.78 |
| 30 glucose | 0.784 | 0.81 |
| 30 glucose + 20 isomaltulose | 1.61 | 1.1 |
| 30 glucose + 40 isomaltulose | 1.23 | 1.15 |

n value per treatment = 120

TABLE 4.2
Somatic loblolly pine normalcy, relative to 40 sucrose

| | | % Partial | | | |
|---|---|---|---|---|---|
| | | Extracted | | | |
| | % Normal | Normal | | % Abnormal | |
| treatment | p = 0.5152 | p = 0.0002 | | p = 0.0016 | |
| 40 sucrose | 1.00 | 1.0 | A | 1.00 | A |
| 40 sucrose + | 1.58 | 3.0 | ABC | .90 | AB |
| 20 isomaltulose | | | | | |
| 40 sucrose + | 1.43 | 5.7 | BC | 0.83 | AB |
| 40 isomaltulose | | | | | |
| 30 glucose | 0.741 | 1.7 | AB | 0.98 | A |
| 30 glucose + | 1.72 | 1.7 | AB | 0.94 | AB |
| 20 isomaltulose | | | | | |
| 30 glucose + | 1.72 | 7.0 | C | 0.76 | B |
| 40 isomaltulose | | | | | |

n value per treatment = 120

TABLE 4.3
Somatic loblolly pine root presence, relative to 40 sucrose

| | |
|---|---|
| | % Root Presence |
| treatment | p < 0.0001 |

| | | |
|---|---|---|
| 40 sucrose | 1.00 | C |
| 40 sucrose + 20 isomaltulose | 1.53 | BC |
| 40 sucrose + 40 isomaltulose | 1.81 | AB |
| 30 glucose | 0.823 | C |
| 30 glucose + 20 isomaltulose | 1.33 | BC |
| 30 glucose + 40 isomaltulose | 2.76 | A |

n value per treatment = 120

Taken together, these results suggest that isomaltulose addition to a manufactured seed gametophyte medium provides a novel way to significantly improve both zygotic and somatic loblolly pine embryo root elongation, root presence, lateral root presence, epicotyl length, and seed extraction normalcy. Treatment efficacy demonstrated in three different genotypes suggests possible applicability across a wider range of species. Isomaltulose addition provides a significant improvement to common problems associated with somatic embryos that remain critical to germination and survival.

What is claimed:

1. A nutritive media for a manufactured seed comprising a plant non-metabolizable sugar.

2. The nutritive media of claim 1, wherein the sugar is selected from the group consisting of turanose, isomaltulose, lactulose, 3α-galactobiose, lactitol, lactose, 4β-galactobiose, palatinitol, and melibiose.

3. The nutritive media of claim 2, wherein the sugar is at a concentration of 1 to 40 g/l.

4. The nutritive media of claim 2, wherein the sugar increases the osmolality of the media in an amount sufficient to improve germination of the manufactured seed.

5. The nutritive media of claim 2, further comprising glucose or sucrose.

6. The nutritive media of claim 5, wherein the glucose is at a concentration of at least 30 g/l.

7. The nutritive media of claim 5, wherein the sucrose is at a concentration of at least 40 g/l.

8. The nutritive media of claim 2, further comprising at least eight components selected from the group consisting of an adsorbent material, urea, KNO₃, NH₄NO₃, CuCl₂, CuSO₄, KI, KH₂PO₄, CaCl₂, MgSO₄, Na₂EDTA, FeSO₄, ferric citrate, MnSO₄, MnCl₂, H₃BO₃, ZnSO₄, CoCl₂, Na₂MoO₄, (NH₄)₂MoO₄, thiamine, riboflavin, pyridoxine, HCl, Ca-pantothenate, nicotinic acid, biotin, folic acid, and myo-inositol.

9. The nutritive media of claim 8, further comprising L-asparagine, L-glutamine, L-lysine-2HCl, DL-serine, L-proline, L-arginine-HCl, L-valine, L-alanine, L-leucine, L-threonine, L-phenylalanine, L-histidine, L-isoleucine, L-methionine, L-glycine, L-tyrosine, and L-cysteine.

10. The nutritive media of claim 8, further comprising at least one component selected from the group consisting of from 10 g/l to 100 g/l of an adsorbent material, from 350 mg/l to 450 mg/l of NH₄NO₃, from 2000 mg/l to 3000 mg/l of KH₂PO₄; and at least one component selected from the group consisting of: from 5 mg/l to 25 mg/l of FeSO₄, from 600 mg/l to 1500 mg/l of MgSO₄, from 150 mg/l to 300 mg/l of myo-inositol, from 1.5 mg/l to 3.0 mg/l of thiamine-HCl, from 0.30 mg/l to 0.80 mg/l of pyridoxine-HCl, from 1.5 mg/l to 3.0 mg/l of nicotinic acid, from 0.15 mg/l to 0.30 mg/l of riboflavin, from 0.75 mg/l to 2.0 mg/l of Ca-pantothenate, from 0.01 mg/l to 0.03 mg/l of biotin, and from 0.15 mg/l to 0.30 mg/l of folic acid.

11. A manufactured seed comprising:
(a) a seed coat;
(b) a cotyledon restraint comprising a centrally located cavity; and
(c) a nutritive media comprising a plant non-metabolizable sugar.

12. The manufactured seed of claim 11, further comprising a plant embryo within the centrally located cavity of the cotyledon restraint.

13. The manufactured seed of claim 11, wherein the plant non-metabolizable sugar increases the osmolality of the nutritive media in an amount sufficient to improve germination of the manufactured seed.

14. The manufactured seed of claim 11, wherein the nutritive media substantially fills the interior of the seed coat and surrounds the cotyledon restraint.

15. The manufactured seed of claim 11, wherein the non-metabolizable sugar is selected from the group consisting of turanose, isomaltulose, lactulose, 3α-galactobiose, lactitol, lactose, 4β-galactobiose, palatinitol, and melibiose.

16. The manufactured seed of claim 15, wherein the non-metabolizable sugar is at a concentration of 1-40 g/l.

17. The manufactured seed of claim 15, wherein the nutritive media further comprises sucrose or glucose.

18. The manufactured seed of claim 15, wherein the nutritive media further comprises at least one component selected from the group consisting of from 10 g/l to 100 g/l of an adsorbent material, from 350 mg/l to 450 mg/l of NH₄NO₃, from 2000 mg/l to 3000 mg/l of KH₂PO₄; and at least one component selected from the group consisting of: from 5 mg/l to 25 mg/l of FeSO₄, from 600 mg/l to 1500 mg/l of MgSO₄, from 150 mg/l to 300 mg/l of myo-inositol, from 1.5 mg/l to 3.0 mg/l of thiamine-HCl, from 0.30 mg/l to 0.80 mg/l of pyridoxine-HCl, from 1.5 mg/l to 3.0 mg/l of nicotinic acid, from 0.15 mg/l to 0.30 mg/l of riboflavin, from 0.75 mg/l to 2.0 mg/l of Ca-pantothenate, from 0.01 mg/l to 0.03 mg/l of biotin and from 0.15 mg/l to 0.30 mg/l of folic acid.

19. The manufactured seed of claim 18, wherein the nutritive media further comprises L-asparagine, L-glutamine, L-lysine-2HCl, DL-serine, L-proline, L-arginine-HCl, L-valine, L-alanine, L-leucine, L-threonine, L-phenylalanine, L-histidine, L-isoleucine, L-methionine, L-glycine, L-tyrosine, and L-cysteine.

20. The manufactured seed of claim 11, wherein the plant embryo is a conifer embryo.

21. The manufacture seed of claim 11, wherein the nutritive media is within the cavity of the cotyledon restraint in direct contact with the plant embryo.
